(19) United States
(12) Patent Application Publication
(10) Pub. No.: US 2025/0309761 A1
(43) Pub. Date: Oct. 2, 2025

(54) METHODS AND APPARATUS TO REDUCE INTERFERENCE ASSOCIATED WITH A CHARGE PUMP

(71) Applicant: Texas Instruments Incorporated, Dallas, TX (US)

(72) Inventors: Anumalasetty Jayaprakash, Nellore (IN); Ashish Ojha, Bangalore (IN); Ganapathi Shankar, Dallas, TX (US); Venkata Naresh Kotikelapudi, Bangalore (IN)

(21) Appl. No.: 18/620,622

(22) Filed: Mar. 28, 2024

(51) Int. Cl. H02M 3/07; H02M 1/32; H02M 1/44

(52) U.S. Cl. CPC H02M 3/07; H02M 1/32; H02M 1/44

(57) ABSTRACT

Methods, apparatus, and systems are described to facilitate phase detection for data clock synchronization. An example apparatus includes a charge pump having a first capacitor, a second capacitor, and a terminal; and clamping circuitry having a terminal, the terminal of the clamping circuitry coupled to the first capacitor via the terminal and the second capacitor via the terminal.

### TECHNICAL FIELD

This description relates generally to circuits, and, more particularly, to reduce interference associated with a charge pump.

### BACKGROUND

In some systems (e.g., automotive systems), a driver may be implemented to drive a component, such as a motor. To drive the motor, a processing device may output pulse width modulated (PWM) signals to the driver and the driver uses a voltage or current to drive the component. The driver includes a high side transistor and a low side transistor. A first PWM signal controls the high side transistor and a second PWM signal (e.g., differential from the first PWM signal) controls the low side transistor. To be able to properly control the high side transistor, the voltage needs to be higher than the supply voltage of the driver. To generate voltages higher than a supply voltage, a charge pump is used. A charge pump is a circuit that includes capacitors configured to generate a voltage higher than a supply voltage.

### SUMMARY

For reducing interference associated with a charge pump, an example apparatus includes a charge pump having a first capacitor, a second capacitor, and a terminal. The apparatus includes clamping circuitry having a terminal, the terminal of the clamping circuitry coupled to the first capacitor via the terminal and the second capacitor via the terminal. Other examples are described.

For reducing interference associated with a charge pump, an example apparatus includes a first current mirror having a first terminal, a second terminal, a third terminal, and a fourth terminal. The apparatus includes a second current mirror having a first terminal, a second terminal, a third terminal, and a fourth terminal, the first terminal of the second current mirror coupled to the second terminal of the first current mirror. The apparatus includes a current source circuit having a first terminal and a second terminal, the first terminal of the current source circuit coupled to the second terminal of the second current mirror. The apparatus includes a first transistor having a first current terminal and a second current terminal, the second current terminal of the first transistor coupled to the second terminal of the second current mirror and the first terminal of the current source circuit. The apparatus includes a third current mirror having a first terminal, a second terminal, a third terminal, and a fourth terminal, the third terminal of the third current mirror coupled to the first current terminal of the first transistor. The apparatus includes a second transistor having a first current terminal and a second current terminal, the first current terminal of the second transistor coupled to the fourth terminal of the third current mirror. The apparatus includes a resistor having a first terminal and a second terminal, the first terminal of the resistor coupled to the second current terminal of the second transistor. The apparatus includes a third transistor having a control terminal, a first current terminal, and a second current terminal, the control terminal of the third transistor coupled to the second current terminal of the second transistor and the first terminal of the resistor. Other examples are described.

For reducing interference associated with a charge pump, an example system includes a charge pump having a first terminal, a second terminal and a third terminal. The system includes clamping circuitry including a terminal, the terminal of the clamping circuitry coupled to the second terminal of the charge pump. The system includes a driver having a high side switch, the high side switch coupled to the third terminal of the charge pump. Other examples are described.

### BRIEF DESCRIPTION OF THE DRAWINGS

FIG. 1 is an example vehicle that includes a clamp that reduces interference associated with a charge pump.

FIG. 2 is an example circuit implementation of a driver of FIG. 1.

FIG. 3 is an example circuit implementation of a charge pump and a clamp of FIG. 1.

FIG. 4 is a timing diagram associated with the circuitry of FIG. 3.

FIG. 5 is an example circuit implementation of fixed clamped circuitry of FIG. 3.

FIG. 6 is an alternative example circuit implementation of a charge pump and a clamp of FIG. 1.

FIG. 7 is an example circuit implementation of the variable clamped circuitry of FIG. 6.

FIGS. 8A-8B are frequency diagrams that illustrate interface associated with a clamp.

The same reference numbers or other reference designators are used in the drawings to designate the same or similar (functionally or structurally) features.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines or boundaries may be idealized. In reality, the boundaries or lines may be unobservable, blended, irregular, etc.

In some systems, such as automotive systems, a computing device controls various components of a system using a driver. A computing device can output a signal to control a driver drive a motor, an LED, an amplifier, etc. For example, if a user presses a button to close a window of a vehicle, a computing system of the vehicles sends one or more signals to a driver. The driver, based on the signal(s) from the computing device, outputs a voltage or current to the motor that controls the window to open or close the window.

Some drivers include a high side transistor and a low side transistor. If the high side transistor is enabled and the low side transistor is disabled, a supply voltage is applied to the component that is being driver. As used herein, an enabled transistor is a transistor that operates a closed switch to create a short between the source terminal and the drain terminal of the transistor. As used herein, a disabled transistor is a transistor that operates as an open switch to create an open circuit between the source terminal and the drain terminal of the transistor. If the high side transistor is disabled and the low side transistor is enabled, the component that is being driven is grounded.

In some systems, to enable the high side transistor, the voltage applied to the control terminal (e.g., gate terminal) of the high side transistor needs to be higher than the supply voltage. A charge pump can be used to charge the gate of the high side transistor so that a smaller voltage and or current can be used to control the high side transistor. The charge pump includes capacitors that charge and discharge to generate an output voltage that is higher than a supply voltage. The charge pump includes a plurality of switches that can be enabled (e.g., to create a short) or disabled (e.g., to create an open circuit) to charge or discharge the capacitors to generate the output voltage. For example, a first group of the switches are enabled and the second group of switches are disabled to charge one or more of the capacitors. Also, the first group of switches are disabled and the second group of switches are enabled to increase the output voltage by charging one or more capacitors. Accordingly, if the output voltage satisfies the threshold, the load utilizes the output voltage to decrease the output voltage while the capacitors charge or recharge. If the output voltage drops below the threshold, the capacitors discharge to increase the output voltage back above the threshold. The switching frequency of the switches in such charge pumps to charge or discharge the one or more capacitors is based on the load. The larger the load, the higher the switching frequency, the lower the load the lower the switching frequency.

Although charge pumps are highly efficient and cost-effective, the switching frequency of the switches creates at least one of noise (e.g., electromagnetic noise) or interference at the switching frequency and at harmonics of the switching frequency. For example, the charge transfer that occurs when the signals applied to the switches change creates a current spike. The current spike creates interference (e.g., EMI). A filter can be implemented to filter or reduce the effect of noise or interference introduced by the switching frequency of the charge pump. In some examples, the filter could be placed on chip supply terminal (VM) to prevent interference generated by charge pump to back to other components or the source. However, because some charge pumps change switching frequency based on the load, the frequency of the current spikes caused by the switching changes, thereby creating a broadband spectrum of EMI noise. Accordingly, it may be difficult, expensive, or impossible to filter out the broad frequency range of the noise due to the broad switching frequency to compensate for changes in load. Examples described herein result in a charge pump with lower electromagnetic interference with a fast load transient response.

Examples described herein utilize a voltage clamp to clamp a voltage at a terminal of the charge pump to reduce or eliminate the variable frequency used to control the switches of the charge pump. By reducing or eliminating the variable switching frequency, examples described herein narrow the frequency of the noise. Accordingly, a simpler filter can be utilized to filter out the generated noise. Examples described herein utilize a fixed voltage clamp (e.g., that clamps a voltage at a terminal of the charge pump to a fixed voltage) or a variable voltage clamp. The variable voltage clamp changes the amount of voltage that the terminal of the charge pump is clamped to based on the load. For example, if the load is larger, the voltage output by the variable clamp will be higher and, if the load is smaller or there is no load, the voltage output by the variable clamp will be lower. By changing the clamp voltage, the charge pump can maintain a fixed switching frequency but increase or lower the amount of charging that is done to the capacitors based on the load. Because the switching frequency is fixed, the noise generated by the switching frequency will only occur near the switching frequency and harmonics of the switching frequency. Thus, a low cost/simple filter can be implemented to eliminate, or otherwise reduce, the noise.

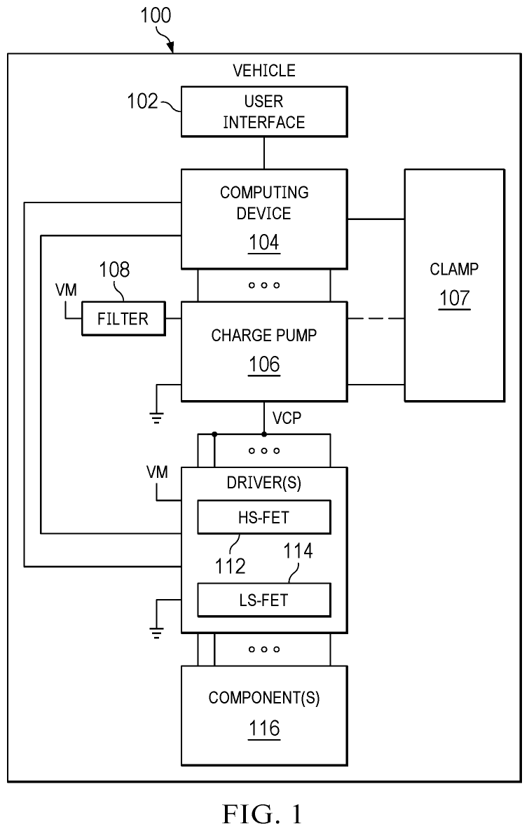

FIG. 1 illustrates an example vehicle 100 to implement a charge pump with reduced electromagnetic interference. The vehicle 100 includes an example user interface 102, an example computing device 104, an example charge pump 106, example clamp circuitry 107, an example filter 108, example driver(s) 110, which include a high side transistor 112 and a low side transistor 114, and example components (a) 116. Although the example charge pump 106 and clamp 107 of FIG. 1 is implemented in the vehicle 100, the charge pump 106 and the clamp 107 can be implemented in any system. The vehicle 100 can be a car, a truck, a plane, a train, a boat, or any other type of vehicle.

The user interface 102 of FIG. 1 is coupled to the computing device 104. The user interface 103 may be a touchscreen, a button, a switch, a microphone, a camera, etc. A user can interact with the user interface 103 to control one or more driver(s) 110 to drive one or more component(s) 116. For example, the user can interact with the user interface 103 to signal to the computing device 104 to roll down the window.

The computing device 104 of FIG. 1 is coupled to the user interface 102, the charge pump 106, the driver 110, and the clamp circuitry 107. The computing device 104 obtains a request to drive one or more of the components 116 from a user. In some examples, the request to drive one or more components(s) 116 may be from a device. To drive the component(s) 116 the computing device outputs one or more signals to the driver 110. For example, the computing device can output two differential pulse width modulated signals to control the high and low side transistors 112, 114 to drive the one or more components 116. In some examples, the computing device 104 outputs one pulse width modulated signal and a differential/inverted pulse width modulated signal is generated using logic circuitry (e.g., a NOT gate) and both the PWM signal and the inverter PWM signal are used to control the transistors 112, 114 of the driver 110. Also, the computing device 104 outputs one or more clock signals (e.g., a differential clock signal) to the charge pump 106 to control switches of the charge pump 106 to generate an output voltage/current used to drive the high side transistors(s) 112 of the driver(s) 110. In some examples, the computing device 104 outputs one clock signal and a differential/inverter clock signal is generated using logic circuitry and both the clock signals are used to control the charge pump 106. Also, the computing device 104 can output a control signal to the clamp circuitry 107 to enable the clamping circuitry 107.

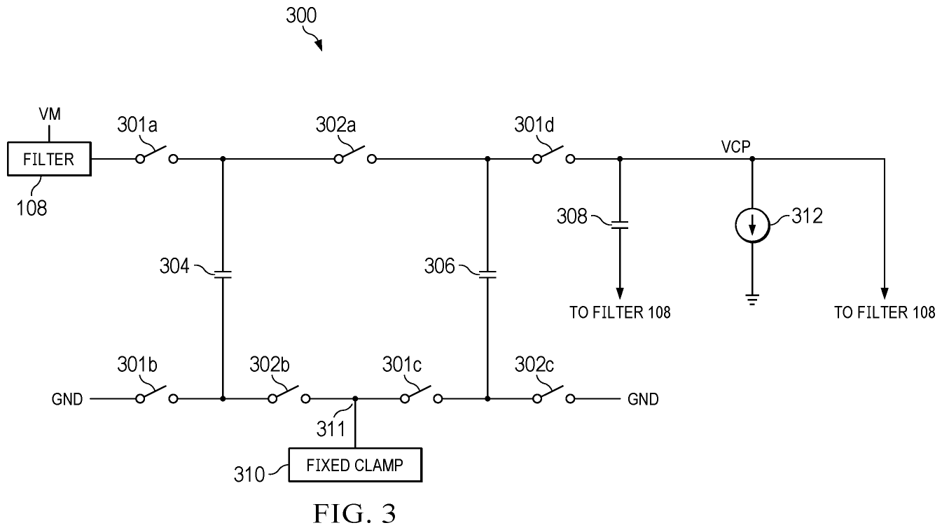

The charge pump 106 of FIG. 1 is coupled to a supply voltage terminal (e.g. via the filter 108), a common terminal (e.g., ground), the computing device 104, the clamping circuitry 107, and the filter 108. The charge pump 106 includes switches and capacitors to generate an output voltage that is higher than the supply voltage. The charge pump 106 can be structured to be able to double the supply voltage, triple the supply voltage, etc. As further described below, the clamp circuitry 107 can clamp a voltage at a terminal of the charge pump 106 to clamp the output voltage of the charge pump 106. The output voltage/current of the charge pump 106 is transmitted to the high side transistor 112 via the filter 108. The charge pump 106 is further described below in conjunction with FIG. 3.

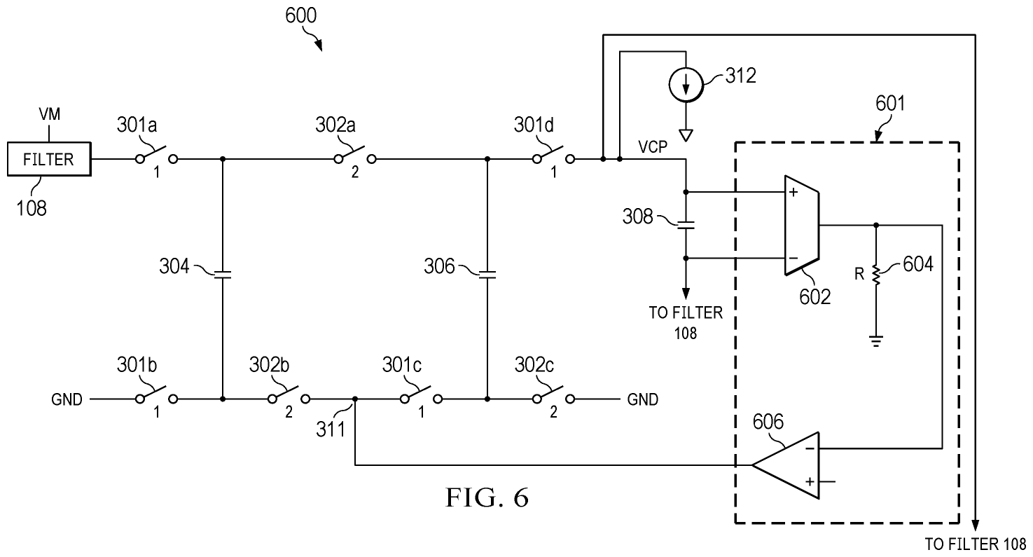

The clamping circuitry 107 of FIG. 1 is coupled to the computing device 104 and the charge pump 106. The clamping circuitry 107 clamps the output voltage of the charge pump 106 by clamping the voltage at a terminal in the charge pump 106. By clamping the output voltage, the variation in the switching frequency used to control the switches in the charge pump 106 is reduced or eliminated. Thus, the frequency of the EMI noise caused by the charge pump 106 is narrowed. The clamping circuitry 107 may be a fixed clamp or a variable clamp. An example implementation of a fixed clamp is further described below in conjunction with FIG. 3. An example implementation of the variable clamp is further described below in conjunction with FIG. 6.

The filter 108 of FIG. 1 is coupled to the charge pump 106 and a supply terminal VM. At every clock cycle, during a flycap charging phase of control of the charge pump 106, there will be a current spike on at the VM terminal, which results interference (e.g., EMI). The filter 108 filters out the interference generated by the charge pump 106. The filter 108 is structured to filter out interference at frequencies that correspond to the switching frequency of the charge pump 106. For example, if the clamp 107 is a variable clamp, the switching frequency will be a fixed frequency (e.g., 400 kiloHertz (KHz)). Accordingly, the filter 108 can be structured to filter out interference at one or more of the fixed switching frequency or corresponding harmonic frequencies. The filter 108 outputs the filtered output voltage/current to the driver(s) 110.

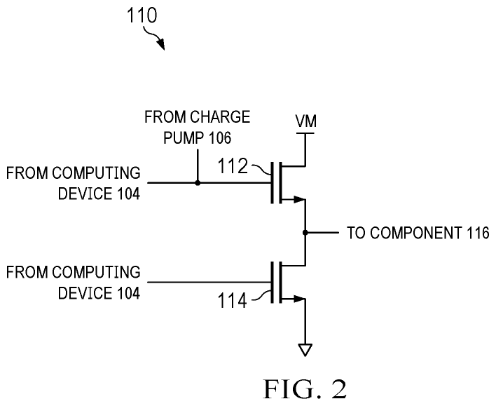

The drivers(s) 110 of FIG. 1 is/are coupled to the supply terminal, a ground terminal, the filter 108, the computing device, 104, and the component(s) 116. The driver(s) 110 drive corresponding component(s). For example, each driver may drive a particular component. Thus, if the driver(s) 110 receive(s) control signal(s) from the computing device(s) 104, the driver 110 controls the component(s) 116. The driver(s) each include a high side transistor 112 and a low side transistor 114. In the example of FIG. 1, the high side transistor 112 is a high side (HS) field effect transistor (FET) and the low side transistor 114 is a low side (LS) field effect transistor (FET). However, the transistors 112, 114 could be any type of transistor. The output voltage from the filter 108 is used to drive the high side transistor 112 because the voltage/current needed to drive the high side transistor 112 is higher than the supply terminal. The computing device 104 can directly control the low side transistor 114. An example implementation of one of the driver(s) 110 is further described below in conjunction with FIG. 2.

The component(s) 116 of FIG. 1 are coupled to the corresponding driver(s) 110. The component(s) 116 may be motor(s), amplifier(s), light emitting diodes (LEDS), or any other device that can be controlled by the driver(s) 110.

FIG. 2 is an example circuit implementation of one of the driver(s) 110 of FIG. 1. The driver 110 of FIG. 1 includes the example high side FET 112 and the example low side FET 114.

The high side FET 112 of FIG. 2 includes a control terminal (e.g., a gate terminal), a first current terminal (e.g., a drain terminal) and a second current terminal (e.g., a source terminal). The control terminal of the high side FET 112 is coupled to the computing device 104 and the charge pump 106. The first current terminal of the high side FET 112 is coupled to the supply terminal VM. The second current terminal of the high side FET 112 is coupled to the first current terminal of the low side FET 114 and the component 116. In the example of FIG. 2, the high side FET 112 is an n-channel metal oxide semiconductor (NMOS) FET. However, the high side FET 112 may be a different type of transistor. As further described below, if the voltage/current at the control terminal of the high side FET 112 is high (e.g., 2×VM, 3×VM, or above a threshold voltage), the high side FET 112 operates as a closed switch, thereby causing the supply voltage to be applied to the component 116. If the voltage at the control terminal of the high side FET is low (e.g., 0 V or below the threshold voltage), the high side FET 112 operates as an open switch, thereby decoupling the supply voltage from the component 116.

The low side FET 114 of FIG. 2 includes a control terminal (e.g., a gate terminal), a first current terminal (e.g., a drain terminal) and a second current terminal (e.g., a source terminal). The control terminal of the low side FET 114 is coupled to the computing device 104. The first current terminal of the low side FET 114 is coupled to the second current terminal of the high side FET 112 and the component 116. The second current terminal of the low side FET 114 is coupled to a common terminal (e.g., ground). In the example of FIG. 2, the low side FET 114 is an n-channel metal oxide semiconductor (NMOS) FET. However, the low side FET 114 may be a different type of transistor. As further described below, if the voltage at the control terminal of the low side FET 114 is high (e.g., VM or above a threshold voltage), the low side FET 114 operates as a closed switch, thereby causing the ground voltage (e.g., 0 V) to be applied to the component 116. If the voltage at the control terminal of the low side FET is low (e.g., 0 V or below the threshold voltage), the low side FET 114 operates as an open switch, thereby decoupling the ground terminal from the component 116.

In operation, the charge pump 106 pumps current to charge the gate terminal (e.g., the control terminal) of the high side FET 112. After the gate is charged, the computing device 104 can control the transistor 112 using digital logic (e.g., a high voltage to enable the transistor 112 and a low voltage to disable the transistor 112). The computing device 104 outputs differential PWM signals to the FETS 112, 114. For example, a first PWM signal is applied to the control terminal of the high side FET 112 and a second inverted PWM signal is applied to the control terminal of the low side FET 114. In this manner, during operation, only one of the FETs 112, 114 will be enabled (e.g., operating as a closed switch) at a time. Thus, the component 116 will either receive the VM voltage or the ground voltage. For example, if the computing device 104 outputs a logic high value to the high side FET 112 and a logic low value to the low side FET 114, the output voltage of the charge pump (e.g., 2 or 3 times VM) is applied to the control terminal of the high side FET 112 to control the high side FET 112 to operate as a closed switch and the low side FET 114 operates as an open switch. Thus, the supply voltage is applied to the component 116. Also, if the computing device 104 outputs a low high value to the high side FET 112 and a logic high value to the low side FET 114, the high side FET 112 operates as an open switch and the low side FET 114 operates as a closed switch. Thus, the ground terminal voltage (e.g. 0 V) is applied to the component 116. Accordingly, the output of the driver 110 is a PWM signal that toggles between VM and 0 V based on the PWM signal output by the computing device 104. In some examples, the computing device 104 may output one or more control signals to one or more digital circuitry (e.g., latches), and the digital circuitry can control the transistors 112, 114 based on the control signal(s) from the computing device 104.

FIG. 3 is an example circuit diagram of an example charge pump 300 and an example fixed clamp 310. The charge pump 300 of FIG. 3 can be used to implement the charge pump 106 of FIG. 1 and the fixed clamp 310 of FIG. 3 can be used to implement the clamping circuitry 107 of FIG. 1. The charge pump 300 includes example switches 301a-301d, 302a-302, example capacitors 304, 306, 308, an example terminal 311, and example current source circuitry 312. The example charge pump 300 of FIG. 3 is structured to operate as a voltage tripler (e.g., including two fly capacitors and a bucket capacitor). However, the charge pump 300 of FIG. 3 could be structured to operate as a voltage doubler (e.g., including one fly capacitor and one bucket capacitor).

The example switches 301a-301d, 302a-302 of FIG. 3 each include a first terminal and a second terminal. If the switches 301a-301d, 302a-302 are implemented by transistors (e.g., MOSFETS), the first terminal of the switches 301a-301d, 302a-302 is a first current terminal (e.g., a source or a drain), the second terminal of the switches 301a-301d, 302a-302 is a second current terminal (e.g., a drain or a source), and the switches 301a-301d, 302a-302 also include a control terminal. If the switches 301a-301d, 302a-302 are implemented by transistors, the control terminals of the switches 301a-301d, 302a-302 are coupled to the computing device 104.

The first terminal of the switch 301a of FIG. 3 is coupled to the filter 108. The second terminal of the switch 301a is coupled to the first terminal of the capacitor 304 and the first terminal of the switch 302a. The first terminal of the switch 301b is coupled to a common terminal (e.g., a ground terminal (GND)). The second terminal of the switch 301b is coupled to the second terminal of the capacitor 304 and the first terminal of the switch 302b. The first terminal of the switch 301c is coupled to the second terminal of the switch 302b and the output terminal of the fixed clamp 310 via the terminal 311. The second terminal of the switch 301c is coupled to the second terminal of the capacitor 306 and the first terminal of the switch 302c. The first terminal of the switch 301d is coupled to the second terminal of the switch 302a and the first terminal of the capacitor 306. The second terminal of the switch 301d is coupled to the first terminal of the capacitor 308, the current source circuitry 312, and the filter 108. The first terminal of the switch 302a is coupled to the second terminal of the switch 301a and the first terminal of the capacitor 304. The second terminal of the switch 302a is coupled to the first terminal of the capacitor 306 and the first terminal of the switch 301d. The first terminal of the switch 302b is coupled to the second terminal of the switch 301b and the second terminal of the capacitor 304. The second terminal of the switch 302b is coupled to the first terminal of the switch 301c and the fixed clamp 310 via the terminal 311. The first terminal of the switch 302c is coupled to the second terminal of the switch 301c and the second terminal of the capacitor 306. The second terminal of the switch 302c is coupled to the common terminal (e.g., GND). The switches 301a-301d, 302a-302c are grouped into two groups. The first group 301a-301d are all enabled (e.g., turned on to create a short circuit) when the second group 302a-302c are disabled (e.g., turned off to create an open circuit) and the first group 301a-301d are disabled when the second group 302a-302c are enabled.

The capacitors 304, 306, 308 of FIG. 3 each include a first terminal and a second terminal. The first terminal of the capacitor 304 is coupled to the second terminal of the switch 301a and the first terminal of the switch 302a. The second terminal of the capacitor 304 is coupled to the second terminal of the switch 301b and the second terminal of the switch 302b. The first terminal of the capacitor 306 is coupled to the second terminal of the switch 302a and the first terminal of the switch 301d. The second terminal of the capacitor 306 is coupled to the first terminal of the switch 301c and the second terminal of the switch 302c. The first terminal of the capacitor 308 is coupled to the second terminal of the switch 301d, the first terminal of the current source circuitry 312, and the filter 108 via the VCP terminal. The second terminal of the capacitor 308 is coupled to the supply terminal (e.g., VM) (e.g., via the filter 108). The capacitors 304, 306 are flying capacitors and the capacitor 208 is a bucket capacitor. A flying capacitor is a capacitor that increases the supply voltage and transfers the increased supply voltage to a bucket capacitor. A bucket capacitor is a capacitor that stores the total charge from the flying capacitors.

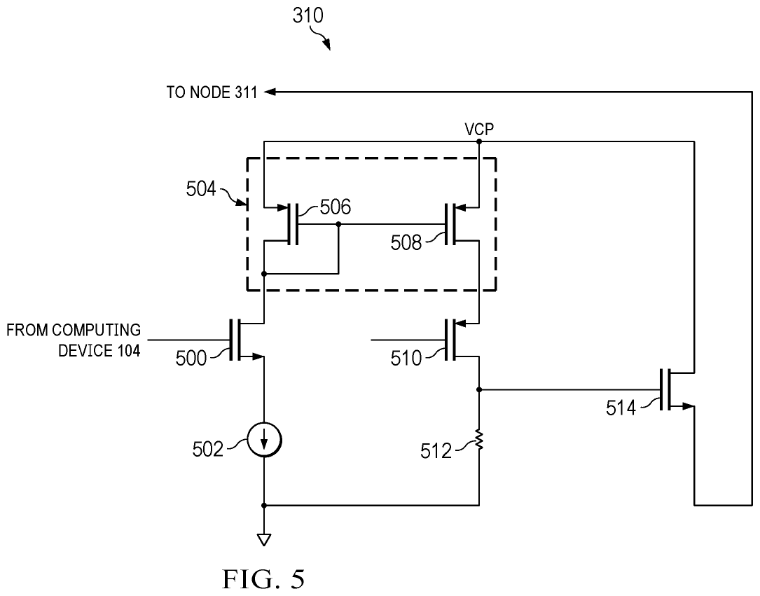

The fixed clamp 310 of FIG. 3 includes an output terminal. The output terminal of the fixed clamp 310 is coupled to the second terminal of the switch 302b and the first terminal of the switch 301c. The fixed clamp 310 clamps the voltage at the terminal 311 to a fixed voltage. The fixed clamp 310 controls the output terminal (e.g., the VCP terminal) of the charge pump 300 so that the switching frequency used to control the switches 301a-301d and 302a-302c is fixed. In this manner, the noise caused by the switching frequency will be limited to the switching frequency and harmonics of the switching frequency. For example, instead of changing the switching frequency, the width of the clock pulse can be adjusted to increase the output voltage with more or less charge. Because the clock pulse is fixed, the corresponding noise will occur at fixed frequencies. Therefore, the filter 108 can be simplified to filter out the noise at one or more of the switching frequency or the harmonic frequency(ies). In some examples, the filter 108 can be structured to output two or more fixed voltage used to clamp the terminal 311 of the charge pump (e.g., a first voltage for a smaller output charge and a second voltage for a larger output charge). An example implementation of the fixed clamp 310 is further described below in conjunction with FIG. 5.

The current source circuitry 312 of FIG. 3 includes a first terminal and a second terminal. The first terminal of the current source circuitry 312 is couped to the second terminal of the switch 301d, the first terminal of the capacitor 308, and the filter 108. The second terminal of the current source circuitry 312 is coupled to the common terminal (e.g., GND). The current source circuitry 312 discharges or sinks excess charge in the capacitor 308 during zero or low load conditions. The current source circuitry 312 may be implemented using a resistor.

In operation, the computing device 104 outputs control signals to enable the first group of switches 301a-301d and disable the switches 302a-302c, thereby charging the first capacitor 304 and the second capacitor 306 to the supply voltage (the VM voltage). After the capacitors 304, 306 are charged, the computing device 104 outputs control signals to disable the first group of switches 301a-301d and enable the switches 302a-302c. If the switches 301a-301d are disabled and the switches 302a-302c are enabled, the second terminal of the capacitor 304 is coupled to the fixed clamp 310 and the second terminal of the capacitor 304 is coupled to the first terminal of the second capacitor 306. Accordingly, the capacitor 306 will charge to the supply voltage (e.g., Vvm) plus the clamp voltage (Vclamp) output by the fixed clamp 310. After the capacitor 306 is charged to the sum of Vvm and Vclamp, the computing device 104 outputs control signals to enable the first group of switches 301a-301d and disables the switches 302a-302c. If the switches 301a-301d are enabled and the switches 302a-302c are disabled, the first terminal of the capacitor 306 is coupled to the fixed clamp 310 and the second terminal of the capacitor 306 is coupled to the first terminal of the capacitor 308, thereby causing the voltage across the capacitor 308 to increase to Vvm+2*Vclamp. Because the VCP terminal corresponds to the voltage across the capacitor 308, the output voltage of the charge pump is Vvm+2*Vclamp, which is transmitted to the filter 108. However, if the load increases, the Vvm+2*Vclamp voltage may decrease. Accordingly, the fixed clamp 310 may be replaced with a dynamic clamp to adjust the Vclamp voltage based on the output voltage of the charge pump, as further described below in conjunction with FIG. 5.

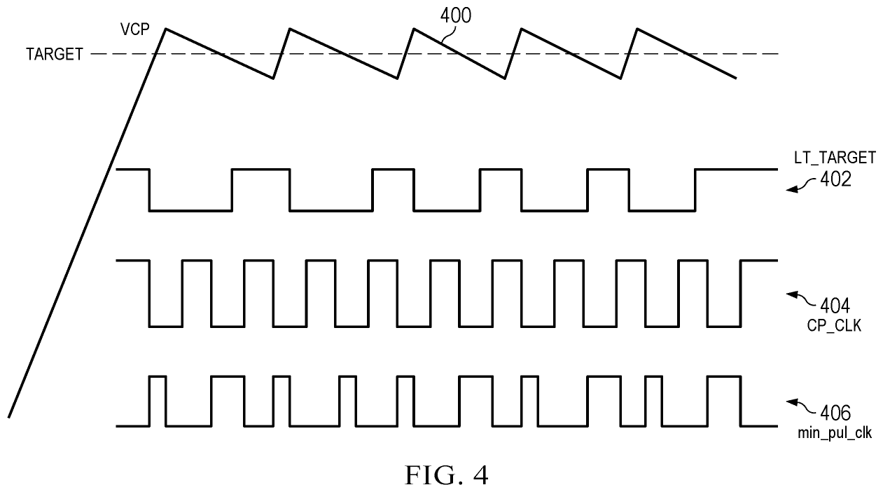

FIG. 4 is an example timing diagram including an example VCP voltage plot 400, an example threshold plot 402 (LT_target), an example clock plot 404, and an example switch control plot 406. The VCP voltage plot 400 corresponds to the voltage at the output terminal of the charge pump 300 (e.g., the VCP terminal). The threshold plot 402 corresponds to when the VCP plot 400 is below a target or threshold voltage. The clock plot 404 corresponds to a clock signal generated or used by the computing device 104. The switch control plot 406 corresponds to the control of the switches 301a-301d and 302a-302c.

As shown in the threshold plot 402, when the VCP plot 400 is below the target, the threshold plot 402 increases from a logic low to a logic high. The threshold plot 402 remains high until the VCP plot 400 rises to above the target. As described above, the width of the clock signal 404 can be adjusted to change the duration of time that the switches 301a-301d are enabled and the duration of time that the switches 302a-302c are disabled, thereby adjusting the charging time of the bucket capacitor 308. For example, if the threshold plot 402 is high, representing that the VCP plot 400 is below the target, the width of the clock plot 404 can be extended, as shown in the switch control plot 406, to provide more time to charge the bucket capacitor 308.

FIG. 5 is an example circuit implementation of the fixed clamp 310 of FIG. 3. The fixed clamp circuitry 310 includes examples transistor 500, 506, 508, 510, 514, example current source circuitry 502, an example current mirror circuitry 504, and an example resistor 512.

The transistor 500 of FIG. 5 includes a control terminal (e.g., a gate terminal), a first current terminal (e.g., a drain terminal) and a second current terminal (e.g., a source terminal). The control terminal of the transistor 500 is coupled to the computing device 104. The first current terminal of the transistor 500 is coupled to the second current terminal of the transistor 506 and the control terminals of the transistors 506, 508. The second current terminal of the transistor 500 is coupled to the first terminal of the current source circuitry 502. The transistor 500 is an N-channel MOSFET transistor. However, the transistor 500 can be any type of transistor. The transistor 500 operates as a switch to enable (e.g., operate as a closed switch) if the voltage at the control terminal of the transistor 500 is a high voltage or disable (e.g., operate as an open switch) if the voltage at the control terminal of the transistor 500 is a low voltage. Thus, the computing device 104 can turn on the clamp circuit 310 or turn off the clamp circuit 310 by applying a low voltage or a high voltage to the control terminal of the transistor 500.

The current source circuitry 502 of FIG. 5 includes a first terminal and a second terminal. The first terminal of the source circuitry 502 is coupled to the second current terminal of the transistor 500. The second terminal of the source circuitry 502 is coupled to a common terminal (e.g., GND). The current source circuitry 502 causes a current to flow from the first terminal of the current source circuitry 502 to the second terminal of the current source circuitry 502 if the transistor 500 is enabled. In some examples, the current source circuitry 502 is implemented by a resistor.

The current mirror circuitry 504 includes a first terminal, a second terminal, a third terminal, and a fourth terminal. The first terminal of the current mirror circuitry 504 is coupled to the output terminal of the charge pump 300 (e.g., the VCP terminal of FIG. 3). The second terminal of the current mirror circuitry 504 is coupled to the first current terminal of the transistor 500. The third terminal of the current mirror circuitry 504 is coupled to the VCP terminal. The fourth terminal of the current mirror circuitry 504 is coupled to the first current terminal of the transistor 510. The current mirror circuitry 504 generates an output current flowing out from the fourth terminal of the current mirror circuitry 504 that mirrors the current flowing out from the second terminal of the current mirror circuitry 504. For example, if the transistors 506, 508 are the same size (e.g., same channel width and length), the current flowing out from the fourth terminal of the current mirror circuitry 504 will be the same as the current flowing out from the second terminal of the current mirror circuitry 504. If the transistors 506, 508 are different sizes, the current flowing out from the fourth terminal of the current mirror circuitry 504 will be a ratio of the current flowing from the second terminal of the current mirror circuitry 504. Accordingly, because the current source circuitry 502 generates a current that flows from the second terminal of the current mirror circuitry 504, the current flowing fourth terminal of the current mirror circuitry 504 will be the same as, or a ratio of, the current generated by the current source circuitry 502.

The current mirror circuitry 504 includes the transistors 506, 508. The transistors 506, 508 each include a control terminal (e.g., a gate terminal), a first current terminal (e.g., a source terminal), and a second current terminal (e.g., a drain terminal). The control terminal of the transistors 506 is coupled to the control terminal of the transistor 508, the second current terminal of the transistor 506, and the first current terminal of the transistor 500. The first current terminal of the transistor 506 is coupled to the VCP terminal. The second current terminal of the transistor 506 is coupled to the control terminal of the transistor 508, the control terminal of the transistor 506, and the first current terminal of the transistor 500. The control terminal of the transistor 508 is coupled to the control terminal of the transistor 506, the second current terminal of the transistor 506, and the first current terminal of the transistor 500. The first current terminal of the transistor 508 is coupled to the VCP terminal. The second current terminal of the transistor 508 is coupled to the first current terminal of the transistor 510.

The transistor 510 includes a control terminal (e.g., a gate terminal), a first current terminal (e.g., a source terminal), and a second current terminal (e.g., a drain terminal). The control terminal of the transistor 510 is coupled to a common terminal to bias the control terminal to a low voltage. The first current terminal of the transistor 510 is coupled to the second terminal of the transistor 508. The second current terminal of the transistor 510 is coupled to the control terminal of the transistor 514 and the first terminal of the resistor 512. The transistor 510 is a PMOS transistor. However, the transistor 510 could be any transistor. The transistor 510 is biased low. In this manner, the transistor 510 is enabled (e.g., operating as a closed switch). The transistor 510 is a high voltage switch to protect the low voltage current mirror circuitry 504 from high voltages.

The resistor 512 of FIG. 5 includes a first terminal and a second terminal. The first terminal of the resistor 512 is coupled to the second terminal of the transistor 510 and the control terminal of the transistor 514. The second terminal of the resistor 512 is coupled to the common terminal (e.g., ground). The current flowing from the fourth output terminal of the current mirror (e.g., corresponding to the current generated by the current source circuitry 502) flow through the resistor 512 to generate a voltage (e.g., I*R, where I is the current at the control terminal of the transistor 514. As further described below, the voltage at the control terminal of the transistor 514 generates the output clamp voltage (Vclamp) output to the terminal 311 of FIG. 3.

The transistor 514 includes a control terminal (e.g., a gate terminal), a first current terminal (e.g., a drain terminal), and a second current terminal (e.g., a source terminal). The control terminal of the transistor 514 is coupled to the second current terminal of the transistor 510 and the first terminal of the resistor 512. The first current terminal of the transistor 514 is coupled to the VCP terminal. The second current terminal of the transistor 514 is coupled to the terminal 311 of the charge pump 300 of FIG. 3. The transistor 514 is an NMOS transistor. However, the transistor 514 could be any type of transistor. The transistor 514 outputs a portion of the voltage at the VCP terminal based on the voltage at the control terminal of the transistor 514. Accordingly, because the voltage at the control terminal of the transistor 514 is a function of one or more of the resistance of the resistor 512, the amount of current generated by the current source circuitry 502 or the characteristics of the current mirror circuitry 504, one or more of the resistance of the resistor 512, the amount of current generated by the current source circuitry 502, or the characteristics of the current mirror circuitry 504 can be adjusted to output a desired fixed clamp voltage to the terminal 311 of FIG. 3.

FIG. 6 includes an example charge pump 600 and an example variable clamping circuitry 601. The charge pump 600 includes the switches 301a-301d, 302a-302c the capacitor 304, 306, 308, the terminal 311, and the current source 312 of FIG. 3. The variable clamping circuitry 601 includes an example transconductor 602, an example resistor 604, and example clamp voltage generation circuitry 606. The charge pump 600 corresponds to the charge pump 300 of FIG. 3. Accordingly, for the sake of brevity, because the components of the charge pump 600 corresponds both structurally and functionally to the components of the charge pump 300 of FIG. 3, but for connections to the transconductor 602, the structure and function of the components of the charge pump 600 will not further be described except for the differences to the charge pump 300 of FIG. 3. Further description of the components can be ascertained from the above description in FIG. 3.

The transconductor 602 of FIG. 6 includes a first input terminal, a second input terminal, and an output terminal. The first input terminal of the transconductor 602 is coupled to the second terminal of the switch 301d, the filter 108, and the first terminal of the capacitor 308 via the VCP terminal. The second input terminal of the transconductor 602 is coupled to the second terminal of the capacitor 308 and the supply terminal. The output terminal of the transconductor 602 is coupled to the first terminal of the resistor 604 and the first input terminal of the clamp voltage generation circuitry 606. The transconductor 602 compares the voltage at the first terminal of the capacitor 308 to the voltage at the second voltage terminal of the capacitor 308 and generates an output current based on the comparison. Because the voltage across the capacitor 308 corresponds to the output voltage of the charge pump 600, the transconductor 602 outputs a current that corresponds to the output voltage of the charge pump 600. For example, if the output voltage of the charge pump 600 decreases (e.g., due to a larger load), the current output by the transconductor 602 will increase, and, if the output voltage of the charge pump 600 increases (e.g., due to a smaller load), the current output by the transconductor 602 will decrease.

The resistor 604 of FIG. 6 includes a first terminal and a second terminal. The first terminal of the resistor 604 is coupled to the output terminal of the transconductor 602 and the first input terminal of the clamp voltage generation circuitry 606. The second terminal of the resistor 604 is coupled to the common terminal (e.g., a ground terminal).

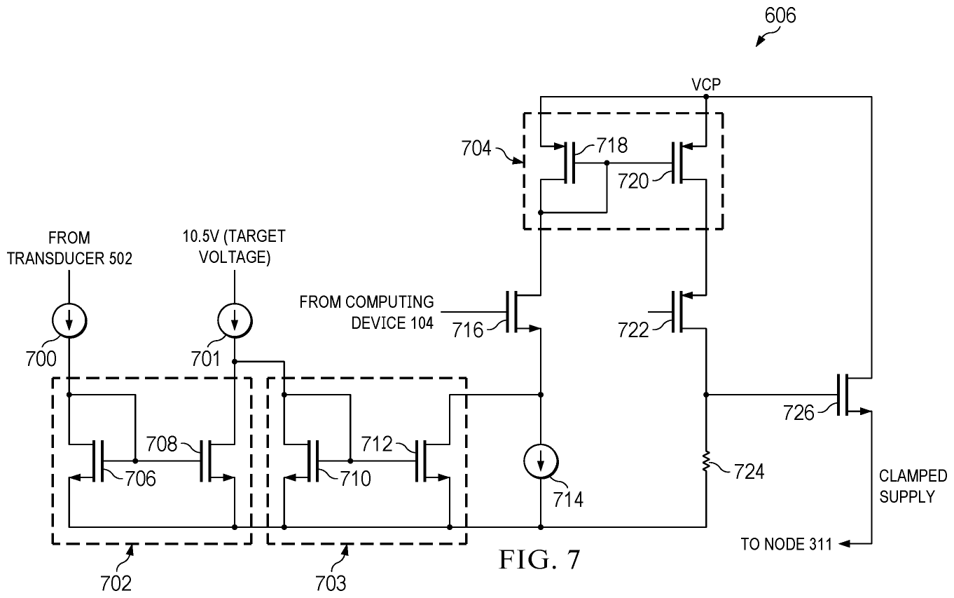

The clamp voltage generation circuitry 606 of FIG. 6 includes a first input terminal, a second input terminal, and an output terminal. The first input terminal of the clamp voltage generation circuitry 606 is coupled to the output terminal of the transconductor 602 and the first terminal of the resistor 604. The second terminal of the clamp voltage generation circuitry 606 is coupled to a 10.5 V supply. However, the 10.5 V supply could be a different amount of voltage supply depending on the desired target clamping voltage to apply to the terminal 311. If the load increases, the voltage across the capacitor 208 may decrease, thereby causing the voltage at the first input terminal of the clamp voltage generation circuitry 606 to decrease below the 10.5 V target voltage. Accordingly, the clamp voltage generation circuitry 606 will increase the clamp voltage applied to the terminal 311, which, in turn, causes the output voltage of the charge pump 600 to increase. If the load decreases, the voltage across the capacitor 208 may increase, thereby causing the voltage at the first input terminal of the clamp voltage generation circuitry 606 to increase above the 10.5 V target voltage. Accordingly, the clamp voltage generation circuitry 606 will decrease the clamp voltage applied to the terminal 311, which, in turn, causes the output voltage of the charge pump 600 to decrease. The clamp voltage generation circuitry 606 is further described below in conjunction with FIG. 7.

FIG. 7 is a circuit implementation of the clamp voltage generation circuitry 606 of FIG. 6. The clamp voltage generation circuitry 606 includes example current source circuitry 700, 701, 714, example current mirrors 702, 703, 704, example transistors 706, 708, 710, 712, 716, 718, 720, 722, 726, and an example resistor 724. The current mirror 704, transistors 716, 718, 720, 722, 726, the current source circuitry 714, and the resistor 724 correspond to the current mirror circuitry 504, the transistors 500, 508, 510, 514, the current source circuitry 502, and the resistor 512 of FIG. 5. Accordingly, for the sake of brevity, because the components of the components 704, 714, 716, 718, 720, 722, 724, 726 corresponds both structurally and functionally to the components of FIG. 5, but for connections to the current mirror 703, the structure and function of the components of the components 704, 714, 716, 718, 720, 722, 724, 726 will not further be described except for the differences to of FIG. 5. Further description of the components can be ascertained from the above description in FIG. 5.

The current source circuitry 700 of FIG. 7 includes a first terminal and a second terminal. The first terminal of the current source circuitry 700 is coupled to the output terminal of the transconductor 602 and the first terminal of the resistor 604. The second terminal of the current source circuitry 700 is coupled to the first terminal of the current mirror 702, which corresponds to the first current terminal of the transistor 706 and the control terminals of the transistor 706, 708. The current source circuitry 700 generates a current (e.g., (VCP−VM)/R) corresponding to the input voltage (e.g., Vcp−Vm) into the first terminal of the current mirror 702. The current source circuitry 700 may be implemented with a resistor.

The current source circuitry 701 of FIG. 7 includes a first terminal and a second terminal. The first terminal of the current source circuitry 701 is coupled to a fixed voltage supply. The second terminal of the current source circuitry 701 is coupled to the first terminal of the current mirror 702, which corresponds to the first current terminal of the transistor 710 and the control terminals of the transistor 710, 712. The current source circuitry 701 generates a current (e.g., 10.5/R) corresponding to the input voltage (e.g., 10.5 V) into the first terminal of the current mirror 703. The current source circuitry 701 may be implemented with a resistor.

The current mirror circuitry 702 of FIG. 7 includes four terminals. The first terminal of the current mirror circuitry 702 is coupled to the second terminal of the current source circuitry 700. The second terminal of the current mirror circuitry 702 is coupled to a common terminal (e.g., ground). The third terminal of the current mirror circuitry 702 is coupled to the second terminal of the current source circuitry 701 and the first terminal of the current mirror 703, which corresponds to the first current terminal of the transistor 710 and the control terminals of the transistors 710, 712. The fourth terminal of the current mirror circuitry 702 is coupled to the common terminal. The current mirror circuitry 702 generates an output current flowing into the third terminal of the current mirror circuitry 702 that mirrors the current flowing into the first terminal of the current mirror circuitry 702. For example, if the transistors 706, 708 are the same size (e.g., same channel width and length), the current flowing out into the third terminal of the current mirror circuitry 702 will be the same as the current flowing into the first terminal of the current mirror circuitry 702. If the transistors 506, 508 are different sizes, the current flowing into the third terminal of the current mirror circuitry 702 will be a ratio of the current flowing into the first terminal of the current mirror circuitry 702. Accordingly, because the current source circuitry 700 generates a current that flows from the first terminal of the current mirror circuitry 702, the current into the third terminal of the current mirror circuitry 702 will be the same as, or a ratio of, the current generated by the current source circuitry 700.

The current mirror circuitry 702 of FIG. 7 includes the transistors 706, 708. Each transistor 706, 708 includes a control terminal, a first current terminal, and a second current terminal. The control terminal of the transistor 706 is coupled to the first current terminal of the transistor 706, the control terminal of the transistor 708, and the second terminal of the current source circuitry 700. The first current terminal of the transistor 706 is coupled to the second terminal of the current source circuitry 700 and the control terminals of the transistors 706, 708. The second current terminal of the transistor 706 is coupled to the common terminal. The control terminal of the transistor 708 is coupled to the first current terminal of the transistor 708, the control terminal of the transistor 706, and the second terminal of the current source circuitry 700. The first current terminal of the transistor 708 is coupled to the second terminal of the current source circuitry 701 the first current terminal of the transistor 712, and the control terminals of the transistors 710, 712. The second current terminal of the transistor 708 is coupled to the common terminal.

The current mirror circuitry 703 of FIG. 7 includes four terminals. The first terminal of the current mirror circuitry 703 is coupled to the second terminal of the current source circuitry 701 and the third terminal of the current mirror 702, which corresponds to the second current terminal of the transistors 708 and the control terminals of the transistors 706, 708. The second terminal of the current mirror circuitry 703 is coupled to the common terminal (e.g., ground). The third terminal of the current mirror circuitry 703 is coupled to the second current terminal of the transistor 716 and the first terminal of the current source circuitry 714. The fourth terminal of the current mirror circuitry 703 is coupled to the common terminal. The current mirror circuitry 703 generates an output current flowing into the third terminal of the current mirror circuitry 703 that mirrors the current flowing into the first terminal of the current mirror circuitry 703. For example, if the transistors 710, 712 are the same size (e.g., same channel width and length), the current flowing out into the third terminal of the current mirror circuitry 703 will be the same as the current flowing into the first terminal of the current mirror circuitry 703. If the transistors 506, 508 are different sizes, the current flowing into the third terminal of the current mirror circuitry 703 will be a ratio of the current flowing into the first terminal of the current mirror circuitry 703.

In the example of FIG. 7, the current that flows into the first terminal of the current mirror 703 corresponds to a difference between the output current (e.g., (Vcp-Vm)/R) of the current source 700 and the output current (e.g., 10.5/R) of the current source 701. For example, if the output current of the current source 700 is equal to the output current of the current source 701, the current into the first terminal of the current mirror 703 will be zero (e.g., due to Kirchoff's current law). If the output current of the current source 700 is lower than the current of the current source 701, the current into the first terminal of the current mirror 703 will correspond to the difference between the current from the current source 701 and the current from the current source 700 (e.g., due to Kirchoff's current law). Because the current into the third terminal of the current mirror 703 corresponds to the current into the first terminal of the current mirror 703, if the current from the current source circuitry 700 is the same as the current from the current source circuitry 701, the current into the third terminal of the current mirror 703 will be zero. Thus, the variable clamping circuitry 606 will output the same voltage as the fixed clamp 310. However, if the load increases, causing the output voltage of the charge pump 600 to decrease, the current output by the current source circuitry 700 will decrease to a current lower than the current output by the current source circuitry 701. Accordingly, the current into the first terminal and third terminal of the current mirror 703 will increase. If the current into the third terminal of the current mirror 703 increases, the current output by the second terminal of the current mirror 704 will increase (e.g., based on Kirchoff's current law). If the current output by the second terminal of the current mirror 704 increases, the current output by the fourth terminal of the current mirror 704 will also increase, thereby increasing the voltage at the control terminal of the transistor 726. Because the clamp voltage output at the second current terminal of the transistor 726 is a function of the voltage at the control terminal of the transistor 726, increasing the voltage at the control terminal results in an increase in the clamping voltage applied to the terminal 311 of the charge pump 600.

The current mirror circuitry 703 of FIG. 7 includes the transistors 710, 712. Each transistor 710, 712 includes a control terminal, a first current terminal, and a second current terminal. The control terminal of the transistor 710 is coupled to the first current terminal of the transistor 710, the control terminal of the transistor 712, the second terminal of the current source circuitry 701, and the first current terminal of the transistor 708. The first current terminal of the transistor 710 is coupled to the second terminal of the current source circuitry 701, the control terminals of the transistors 710, 712, and the first current terminal of the transistor 708. The second current terminal of the transistor 710 is coupled to the common terminal. The control terminal of the transistor 712 is coupled to the first current terminal of the transistor 712, the control terminal of the transistor 710, the second terminal of the current source circuitry 701, and the first current terminal of the transistor 708. The first current terminal of the transistor 712 is coupled to the second terminal of the current source circuitry 714, and the second current terminal of the transistor 716. The second current terminal of the transistor 712 is coupled to the common terminal.

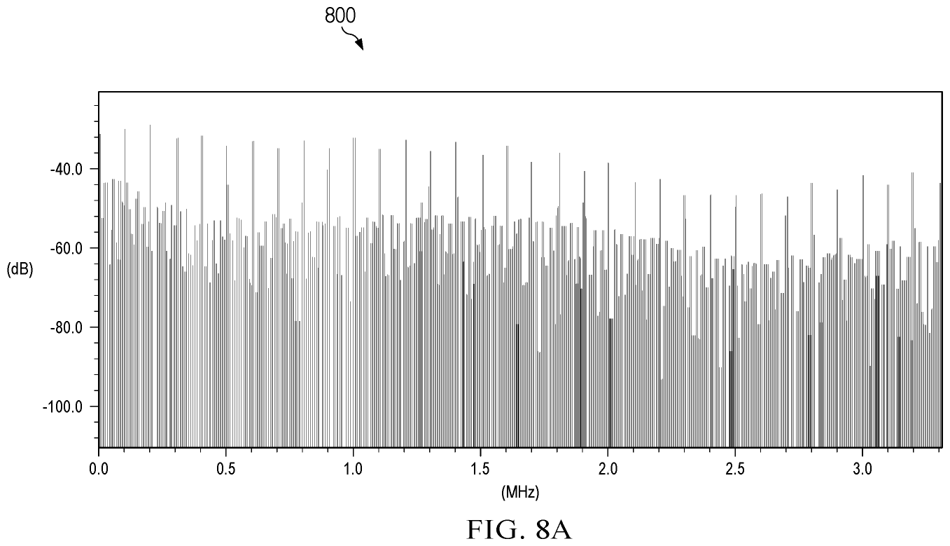

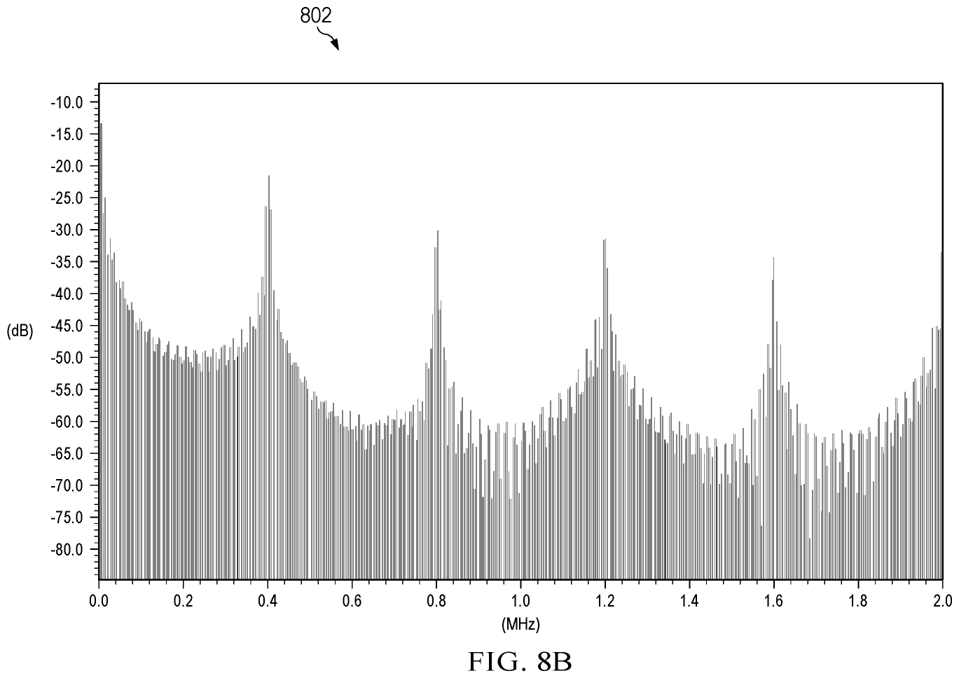

FIGS. 8A and 8B illustrate an example frequency spectrum 800 of a charge pump without a clamp and an example frequency spectrum 802 with the clamping circuitry 601 of FIG. 6. As shown in the frequency spectrum 800 of FIG. 8A, large interference spikes occur throughout the frequency spectrum due to the variable switching frequency needed to generate an output voltage at a desired level. However, as shown in the frequency spectrum 802 of FIG. 8B, the clamping circuitry 601 fixes the switching frequency to a particular frequency (e.g., 400 kHz). In this manner, a large interference spike only occurs at the particular frequency and at harmonics of the particular frequency. Accordingly, the filter 108 can be simplified to filter out noise at the one or more of the particular frequency or the harmonics.

An example manner of implementing the charge pump 106 and the clamping circuitry 107 of FIG. 1 is illustrated in FIGS. 3, 5, 6, and 7. However, one or more of the elements, processes or devices illustrated in FIGS. 3, 5, 6, and 7 may be combined, divided, re-arranged, omitted, eliminated or implemented in any other way.

Further, the computing device 104 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) or field programmable logic device(s) (FPLD(s)).

When reading any of the apparatus or system claims of this patent to cover a purely software or firmware implementation, the computing device 104 of FIG. 1 is hereby expressly defined to include a non-transitory computer readable storage device or storage disk such as a memory, a digital versatile disk (DVD), a compact disk (CD), a Blu-ray disk, etc., including the software or firmware. Further still, the vehicle 100, or the component within the vehicle 100 of FIG. 1 may include one or more elements, processes or devices in addition to, or instead of, those illustrated in FIG. 1, or may include more than one of any or all of the illustrated elements, processes, and devices. As used herein, the phrase “in communication,” including variations thereof, encompasses direct communication or indirect communication through one or more intermediary components, and does not require direct physical (e.g., wired) communication or constant communication, but rather also includes selective communication at periodic intervals, scheduled intervals, aperiodic intervals, or one-time events.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

Descriptors “first,” “second,” “third,” etc. are used herein when identifying multiple elements or components which may be referred to separately. Unless otherwise specified or known based on their context of use, such descriptors do not impute any meaning of priority, physical order, or arrangement in a list, or ordering in time but are merely used as labels for referring to multiple elements or components separately for ease of understanding the described examples. In some examples, the descriptor “first” may be used to refer to an element in the detailed description, while the same element may be referred to in a claim with a different descriptor such as “second” or “third.” In such instances, such descriptors are used merely for case of referencing multiple elements or components.

In the description and in the claims, the terms “including” and “having”, and variants thereof are to be inclusive in a manner similar to the term “comprising” unless otherwise noted. Unless otherwise stated, “about,” “approximately,” or “substantially” preceding a value means +/−10 percent of the stated value. In another example, “about,” “approximately,” or “substantially” preceding a value means +/−5 percent of the stated value. IN another example, “about,” “approximately,” or “substantially” preceding a value means +/−1 percent of the stated value.

The term “couple,” “coupled,” “couples,” and variants thereof, as used herein, may cover connections, communications, or signal paths that enable a functional relationship consistent with this description. For example, if device A generates a signal to control device B to perform an action, in a first example device A is coupled to device B, or in a second example device A is coupled to device B through intervening component C if intervening component C does not substantially alter the functional relationship between device A and device B such that device B is controlled by device A via the control signal generated by device A. Moreover, the terms “couple,” “coupled,” “couples,” or variants thereof, includes an indirect or direct electrical or mechanical connection.

A device that is “configured to” perform a task or function may be configured (e.g., at least one of programmed or hardwired) at a time of manufacturing by a manufacturer to perform the function or may be configurable (or re-configurable) by a user after manufacturing to perform the function or other additional or alternative functions. The configuring may be through firmware or software programming of the device, through a construction or layout of hardware components and interconnections of the device, or a combination thereof.

Although not all separately labeled in the FIGS. 1-7, components or elements of systems and circuits illustrated therein have one or more conductors or terminus that allow signals into or out of the components or elements. The conductors or terminus (or parts thereof) may be referred to herein as pins, pads, terminals (including input terminals, output terminals, reference terminals, and ground terminals, for instance), inputs, outputs, nodes, and interconnects.

The term “or,” when used, for example, in a form such as A, B, or C refers to any combination or subset of A, B, C such as (1) A alone, (2) B alone, (3) C alone, (4) A with B, (5) A with C, (6) B with C, or (7) A with B and with C.

As used herein, a “terminal” of a component, device, system, circuit, integrated circuit, or other electronic or semiconductor component, generally refers to a conductor such as a wire, trace, pin, pad, or other connector or interconnect that enables the component, device, system, etc., to electrically or mechanically connect to another component, device, system, etc. A terminal may be used, for instance, to receive or provide analog or digital electrical signals (or simply signals) or to electrically connect to a common or ground reference. Accordingly, an input terminal or input is used to receive a signal from another component, device, system, etc. An output terminal or output is used to provide a signal to another component, device, system, etc. Other terminals may be used to connect to a common, ground, or voltage reference, e.g., a reference terminal or ground terminal. A terminal of an IC or a PCB may also be referred to as a pin (a longitudinal conductor) or a pad (a planar conductor). A node or a terminal refers to a point of connection or interconnection of two or more terminals. An example number of terminals and nodes may be shown. However, depending on a particular circuit or system topology, there may be more or fewer terminals and nodes. However, in some instances, “terminal”, “node”, “interconnect”, “pad”, and “pin” may be used interchangeably.

Modifications are possible in the described examples, and other examples are possible, within the scope of the claims.

What is claimed is:

1. An apparatus comprising:
a charge pump having a first capacitor, a second capacitor, and a terminal; and
clamping circuitry having a terminal, the terminal of the clamping circuitry coupled to the first capacitor via the terminal and the second capacitor via the terminal.

2. The apparatus of claim 1, wherein:
the first capacitor having a first terminal and a second terminal, the first terminal of the first capacitor coupled to a supply terminal via a first switch and a filter, the second terminal of the first capacitor coupled to a common terminal via a second switch; and
the second capacitor having a first terminal and a second terminal, the first terminal of the second capacitor coupled to the first terminal of the first capacitor via a third switch, the second terminal of the second capacitor coupled to the second terminal of the first capacitor via a fourth switch and a fifth switch, the second terminal of the second capacitor coupled to the common terminal via a sixth switch.

3. The apparatus of claim 2, further including a third capacitor having a first terminal and a second terminal, the first terminal of the third capacitor coupled to the first terminal of the second capacitor via a seventh switch, the second terminal of the third capacitor coupled to the supply terminal via the filter.

4. The apparatus of claim 3, wherein the clamping circuitry includes:
a transconductor having a first input terminal, a second input terminal, and an output terminal, the first input terminal of the transconductor coupled to the first terminal of the third capacitor, the second terminal of the transconductor coupled to the second terminal of the third capacitor and the supply terminal via the filter; and
a resistor having a first terminal and a second terminal, the first terminal of the resistor coupled to the output terminal of the transconductor, the second terminal of the resistor coupled to the common terminal.

5. The apparatus of claim 4, wherein the clamping circuitry further includes an amplifier having a first input terminal, a second input terminal, and an output terminal, the first input terminal of the amplifier coupled to the output terminal of the transconductor and the first terminal of the resistor, the second input terminal of the amplifier coupled to a voltage supply, the output terminal of the amplifier coupled to the first capacitor via the fourth switch and the second capacitor via the fifth switch.

6. The apparatus of claim 3, wherein the filter has an input terminal and an output terminal, the input terminal of the filter is coupled to the supply terminal and the output terminal of the filter is coupled to the first switch and the second terminal of the third capacitor.

7. The apparatus of claim 1, wherein the clamping circuitry is fixed clamping circuitry.

8. The apparatus of claim 1, wherein the clamping circuitry is variable clamping circuitry that varies based on an output voltage of the charge pump.

9. An apparatus comprising:
a first current mirror having a first terminal, a second terminal, a third terminal, and a fourth terminal;
a second current mirror having a first terminal, a second terminal, a third terminal, and a fourth terminal, the first terminal of the second current mirror coupled to the second terminal of the first current mirror;
a current source circuit having a first terminal and a second terminal, the first terminal of the current source circuit coupled to the second terminal of the second current mirror;
a first transistor having a first current terminal and a second current terminal, the second current terminal of the first transistor coupled to the second terminal of the second current mirror and the first terminal of the current source circuit;
a third current mirror having a first terminal, a second terminal, a third terminal, and a fourth terminal, the third terminal of the third current mirror coupled to the first current terminal of the first transistor;
a second transistor having a first current terminal and a second current terminal, the first current terminal of the second transistor coupled to the fourth terminal of the third current mirror;
a resistor having a first terminal and a second terminal, the first terminal of the resistor coupled to the second current terminal of the second transistor; and
a third transistor having a control terminal, a first current terminal, and a second current terminal, the control terminal of the third transistor coupled to the second current terminal of the second transistor and the first terminal of the resistor.

10. The apparatus of claim 9, wherein the third and fourth terminals of the first current mirror are coupled to a common terminal, the third and fourth terminals of the first current mirror are coupled to the common terminal, the second terminal of the current source circuit is coupled to the common terminal, the first and second terminal of the third current mirror are coupled to an output terminal of a charge pump, the second terminal of the resistor is coupled to the common terminal, and the first current terminal of the third transistor is coupled to the output terminal of the charge pump.

11. The apparatus of claim 9, further including a transconductor having an output terminal, the output terminal of the transconductor coupled to the first terminal of the first current mirror.

12. The apparatus of claim 9, further including a voltage source circuit having an output terminal, the output terminal of the voltage source circuit coupled to the second terminal of the first current mirror and the first terminal of the second current mirror.

13. The apparatus of claim 9, wherein the first transistor includes a control terminal, the control terminal of the first transistor structured to be coupled to processor circuitry.

14. The apparatus of claim 9, further including a charge pump, the second current terminal of the third transistor coupled to the charge pump.

15. The apparatus of claim 14, further including a transconductor having a first input terminal a second input terminal and an output terminal, the first and second input terminals of the transconductor coupled to the charge pump, the output terminal of the transconductor coupled to the first terminal of the first current mirror.

16. A system comprising:
a charge pump having a first terminal, a second terminal a third terminal, and a fourth terminal;
clamping circuitry including a terminal, the terminal of the clamping circuitry coupled to the second terminal of the charge pump; and
a driver having a high side switch, the high side switch coupled to the third terminal of the charge pump.

17. The system of claim 16, further including:
a computing device having a first terminal and a second terminal, the first terminal of the computing device coupled to the first terminal of the charge pump; and
a filter including an input and an output, the input of the filter coupled to a supply terminal, the output of the filter coupled to the fourth terminal of the charge pump.

18. The system of claim 16, wherein the clamping circuitry is configured to clamp an output voltage of the charge pump.

19. The system of claim 16, wherein the clamping circuitry is a variable clamp that is configured to adjust a clamping voltage based on an output voltage of the charge pump.

20. The system of claim 16, wherein the charge pump is configured to charge an output capacitor at a fixed frequency.
